(19) United States
(12) Patent Application Publication
(10) Pub. No.: US 2006/0218234 A1
(43) Pub. Date: Sep. 28, 2006

(54) Scheme of sending email to mobile devices

(76) Inventors: Li Deng, San Jose, CA (US); Lawrence Yingqing Cui, San Jose, CA (US)

Correspondence Address: Li Deng, 1047 S. Blaney Ave., San Jose, CA, 95129, US

(21) Appl. No.: 11/386,136

(22) Filed: Mar. 21, 2006

Related U.S. Application Data
(60) Provisional application No. 60/664,986, filed on Mar. 24, 2005.

(51) Int. Cl. G06F 15/16

(52) U.S. Cl. 709/206

(57) ABSTRACT

A method, apparatus, client and server are directed at providing a simplified scheme to deliver email messages that include text message body, and/or MIME attachments from desktop computing devices to messaging (such as SMS) and wireless internet capable phones. A web form is provided for users to compose messages and/or adding MIME attachments from their PC. Also provided in the form are input fields for users to enter device numbers for recipients. Upon submitting the form, message body and MIME attachments are uploaded and stored on the server. An email WAP page that contains the message body and the links to all the MIME attachments is created dynamically and stored on the server. The server then queries a service database and looks up a domain routing table to build the email like messaging addresses for recipients. The server sends a notification message with an embedded link to the email like messaging addresses. The link, such as a URL, a script, an executable, a program, and the like, pointing to the email WAP page, can be invoked from mobile devices. When the link is invoked on the mobile device, it sends a request to the server for the email WAP page. Upon receiving the request from the mobile device, the server collects the information about the mobile device; queries a device database for formats, display and capabilities; locates and loads the email WAP page; converts the MIME attachments to the formats supported by the mobile device; formats the email WAP page for display on the mobile device; delivers the formatted email WAP page to the mobile device. The email WAP page can be viewed, downloaded, and played on the mobile device. The scheme of the present invention supports a device number based authentication. The scheme of the present invention can also be implemented to deliver email messages to multiple mobile devices. The scheme of the present invention can expand the PC to SMS capabilities by enabling text messaging with arbitrary message length.

This application is based on provisional application No. 60/664,986 filed on Mar. 24, 2005.

### FIELD OF THE INVENTION

The present invention relates generally to wireless mobile devices with messaging and wireless internet capabilities, and more particularly but not exclusively to providing a simplified scheme to deliver email messages that include text message body and/or attachments from desktop computing devices to wireless phones.

### BACKGROUND OF THE INVENTION

In today's society, mobile devices are becoming increasingly more powerful. The greatest manifestation is the glue between unwired universes to the Internet domain. 98% of mobile devices out there are SMS and WAP capable. The newest versions of mobile wireless devices are capable of displaying high quality color photos, playing mp3, mp4 and other advanced audio clips, and playing back video clips. Those devices are also capable of accessing customized web pages via wireless internet. In addition, each phone number is assigned an email like SMS address in the form of 1234567890@smsdomain.com, an email like WAP push address in the form of 1234567890@wappushdomain.com, and an email like MMS address in the form of 1234567890@mmsdomain.com. Each mobile phone can be uniquely addressed by its phone number. Those mobile devices are prime candidates for receiving email messages.

In the PC world, email is a very powerful and popular communication tool. However, all email client software is restricted to sending emails from one email address to other email addresses. There is no known system, apparatus, or method that provides functionality within an email system to send a regular email to a mobile phone number, e.g. a mobile phone's addresses. Such a feature will make email even more powerful as wireless phones are popular personal devices users carry all the times.

The system and method of the present invention aims at providing a scheme for enabling the delivery of emails to mobile devices. The present invention broadens the reach of internet emails. The present invention will make it possible for users to send emails directly to mobile devices.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates a logical flow diagram generally showing one embodiment of a simplified scheme to deliver email messages that include text message body and/or attachments from desktop computing devices to wireless phones.

FIG. 4 illustrates one embodiment of logical components and data flow for practicing the invention, in accordance with FIG. 3.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards a client, server, and a method providing a scheme to send email from desktop computing devices to mobile devices. Each mobile phone can be uniquely identified by its phone number. There are three embodiments of email like messaging addresses for mobile devices. The first embodiment is the MMS addresses of mobile devices. For MMS capable phones, MMS address can be used to send or receive multimedia messages. The second embodiment is the SMS addresses of mobile devices. SMS address can be used to send or receive short text messages. The third embodiment is the WAP push addresses of mobile devices. Each mobile phone is assigned an email like SMS address in the form of 1234567890@smsdomain.com. This email like SMS address can be used to receive SMS from any email client or internet email. Each mobile phone is also assigned an email like WAP push address in the form of 1234567890@wappushdomain.com. This WAP push address can be used to push a notification message. Both SMS and WAP push messages can include a link that can be invoked to access a WAP page. In addition, for MMS capable mobile phones, each phone may also be assigned an email like MMS address in the form of 1234567890@mmsdomain.com. This email like MMS address can be used to receive multimedia messages including text, audio, and/or video from any email client or internet email. There are usually one unique SMS domain, one WAP push domain, and/or one unique MMS domain for each carrier or wireless service provider. In addition, each mobile phone has its own SMS, WAP push, and/or MMS message inbox.

The present invention makes use of a service provider database that maps phone numbers to service providers. Such service provider database has the most up to date information about service provider or carrier for any given phone number. An embodiment of such service provider database is LNP database that is currently commercially available in North America. The present invention also provides a domain routing table that maps carriers and service providers to preferred messaging domain: WAP push domain, SMS domain, or MMS domain, and the like. The present invention queries the service provider database to find the wireless service provider or carrier for a given phone number. The present invention then finds the domain name using the domain routing table for the specified carrier. Combining the mobile phone number and the domain name gives a unique email like messaging address for the particular device number. Therefore, the present invention makes it possible to uniquely address each mobile phone address by mobile phone number.

Using email client software or internet email, the sender just needs to specify or enter the mobile phone number to send email messages to mobile devices. In one embodiment, the mobile phone numbers for recipients can be entered in the traditional email address “To/CC/BCC” fields. The email client or internet email conduct initial identification tasks to recognize the address entered by user is a phone number rather then a regular email address before passing to the server of the present invention for further processing. In another embodiment, an option is provided for users to indicate the email is sent specifically to a mobile phone number by either adding a “send to mobile phone” checkbox or providing a “Send to Mobile Phone” field.

Upon sending email message to a mobile device, the email message, the attachments and targeted mobile device numbers are uploaded to a server of the present invention. The uploaded email messages and/or attachments will then be saved on the server.

For each recipient mobile device, the current invention will first query the service provider database by the mobile phone number to find out the wireless service provider or carrier. The system then looks up the domain routing table that maps service provider to preferred messaging domain (such as WAP push domain, SMS domain, or MMS domain, or the like) to find out the messaging domain for the specified carrier. The email like messaging address for the recipient mobile device is then composed using the phone number and the preferred messaging domain name.

An email WAP page will be dynamically created using the text message body and/or MIME attachments. For each dynamically created email WAP page, a unique MSG ID is generated using any of a variety of mechanisms, including a counter, a MD5 hash, and the like. There is one to one relationship between a unique MSG ID and the email WAP page. The server may also associate the mobile device numbers with the unique MSG ID of the email WAP page. The association between the mobile device number and the unique MSG ID may be stored on the server. The association may be used later to authenticate the recipient when the email WAP page is retrieved. The unique MSG ID will be sent as part of the notification message to the targeted mobile devices. The unique MSG ID will be used later to retrieve the email WAP page. The system of the present invention then delivers a notification message, such as an SMS message and the like, to the messaging address of targeted mobile devices. The notification message may embed a link, such as a Uniform Resource Locator (URL), a script, an executable, a program, and the like, that can be invoked on the mobile devices to retrieve the email WAP page on the server. The unique MSG ID of the email WAP page is wrapped in the link embedded in the notification message. Upon invoking the link or the action embedded in the message, mobile device sends a request to the web server.

Upon receiving the request from the mobile device, the server collects the information about the mobile device via user agent profile and/or HTTP headers or the likes on the fly. The server also gets the unique MSG ID of an email WAP page as part of the request. In one embodiment where the recipient mobile device may need to be authenticated, the mobile user will be prompted to enter the device number at the time of retrieving the email WAP page. Once the device number is received by the server, the server will validate the device number against the saved association between unique MSG ID and the device numbers. If the device is authenticated, the email WAP page will be delivered to the mobile device. Otherwise, the request will be rejected.

More information about the particular mobile device will be queried from a mobile device database. This information include, but not limited to, mobile device model, carrier information, the supported rich content formats, the display dimensions and the like. The server then converts all the MIME attachments to the formats supported by the mobile device if needed. The server further formats and optimizes the email WAP page for display on the mobile device. This process may require the resizing of the image or video elements. The server will deliver the formatted and optimized email WAP page to the mobile device as requested.

Upon receiving the email WAP page on mobile device, the mobile user can read the email message and/or the MIME attachments on the mobile device. After reading the email message, mobile user can reply to the sender of the message from within SMS inbox.

As anther embodiment, the present invention can be practiced to extend PC to phone SMS capabilities by enabling the delivery of long text messages from PC to mobile devices with wireless internet capabilities. This embodiment will make it possible for users to send text messages of arbitrary length to SMS and WAP services enabled mobile devices.

Illustrative Operating Environment

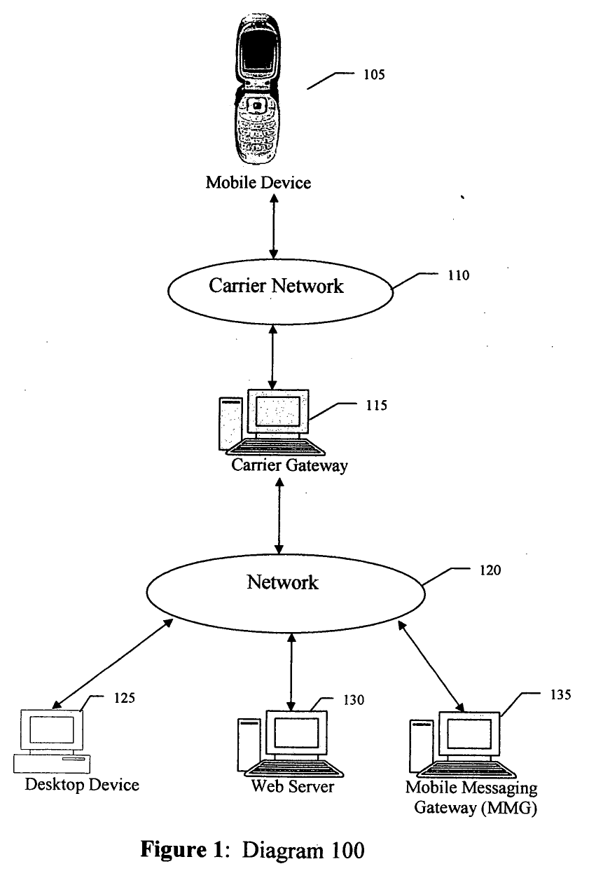

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, diagram 100 includes mobile device 105, carrier network 110, carrier gateway 115, network 120, Mobile Messaging Gateway (MMG) 135, Web Server 130, and desktop computing device 125. Carrier network 110 is in communication with mobile device 105 and Carrier Gateway 115. Network 120 is in communication with and enables communication between carrier gateway 115, MMG 135, Web Server 130, and desktop computing device 125.

Generally, mobile device 105 may include virtually any portable computing device capable of connecting to another computing device to send and receive a message. Mobile device 105 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ WAP to fetch and display mobile markup languages such as Handheld Device Markup Language (HDML), Wireless Markup Language (WML), WMLScript, XHTML Mobile Profile, and the like.

Mobile device 105 may include a keyboard, mouse, speakers, a microphone, and an area on which to display information. Mobile device 105 may further include low-end devices that may have limited storage memory, reduced application sets, low bandwidth for transmission of a communication, and the like.

Mobile device 105 may provide a message, network packet, and the like, that includes a device identifier, such as a Mobile Identification Number (MIN). MINs are provided with each WAP request and uniquely identify each handset. Mobile device 105 may further provide a device number in addition to the device identifier. In one embodiment, mobile device 105 includes a device identification component configured to provide the MIN, phone number, and the like.

Mobile device 105 may be configured to receive a message, such as through a Short Message Service (SMS), Multimedia Message Service (MMS), and the like, from the other computing device, such as MMG 135, and the like. In one embodiment, the message includes a link, such as a URL, script, executable, program, and the like. Mobile device 105 may be further configured to employ the link to request access to another piece of info, such as from MMG 135, and the like. In one embodiment, the other info is an email WAP page. Multimedia, and virtually any other content type, and the like, may be accessible through the included URL, script, executable, program, and the like. For example, the content may include, but not be limited to, a document that contains multiple audio files, video files, graphics files and the like.

Mobile device 105 may further include a client application, and the like, that is configured to manage the actions described above for mobile device 105.

Carrier network 110 is configured to couple mobile device 105 and its components with carrier gateway 115. Carrier network 110 may include any of a variety of wireless sub-networks that may further overlay stand-alone ad-hoc networks, and the like, to provide an infrastructure-oriented connection for mobile device 105. Such sub-networks may include mesh networks, Wireless LAN (WLAN) networks, cellular networks, and the like.

Carrier network 110 may further include an autonomous system of terminals, gateways, routers, and the like connected by wireless radio links, and the like. These connectors may be configured to move freely and randomly and organize themselves arbitrarily, such that the topology of carrier network 110 may change rapidly.

Carrier network 110 may further employ a plurality of access technologies including, but not limited to, 2nd (2G), 2.5 (2.5G), 3rd (3G) generation radio access for cellular systems, WLAN, Wireless Router (WR) mesh, and the like. Access technologies such as 2G, 2.5G, 3G, and future access networks may enable wide area coverage for mobile devices, such as mobile device 105 with various degrees of mobility. For example, carrier network 110 may enable a radio connection through a radio network access such as Global System for Mobil communication (GSM), General Packet Radio Services (GPRS), Enhanced Data GSM Environment (EDGE), Code Division Multiple Access (CDMA), Code Division Multiple Access 2000(CDMA 2000), Wideband Code Division Multiple Access (WCDMA), WIFI, and the like. In essence, carrier network 110 may include virtually any wireless communication mechanism by which information may travel between mobile device 105 and carrier gateway 115.

Carrier gateway 115 may include any computing device capable of connecting with mobile device 105 to enable communications with another computing device, such as MMG 135, Web Server 130, PC desktop 125, another mobile device (not shown), and the like. Such devices that may operate as carrier gateway 115 include, but are not limited to, personal computers, desktop computers, multiprocessor systems, microprocessor-based or programmable consumer electronics, network PCs, servers, and the like.

Carrier gateway 115 typically includes a carrier level service provider's computing device, and related infrastructure. Carrier gateway 115 may be configured to receive a network packet, and the like, from mobile device 105. The network packet, and the like, may include information associated with mobile device 105, such as a device identifier, and the like. The network packet may further include information associated with an end-user of mobile device 105, such as a user account identifier, and the like. Carrier gateway 115 may include additional information in the network packet prior to sending the network packet towards another device, such as MMG 135, Web Server 130, and the like. The additional information may include carrier information including, but not limited to, a carrier gateway grouping, carrier type, carrier identifier, and the like.

Carrier gateway 115 may further receive a network packet from Web Server 130, MMG 135, PC desktop 125, and the like. The received network packet may include an SMS message, a mobile browser readable message, and the like.

Network 120 is configured to couple MMG 135, Web Server 130, PC desktop 125, and the like, with carrier gateway 115. Network 120 is enabled to employ any form of computer readable media for communicating information from one electronic device to another. Also, network 120 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In essence, network 120 includes any communication method by which information may travel between carrier gateway 110, MMG 135, Web Server 130, desktop computing device 125, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal.

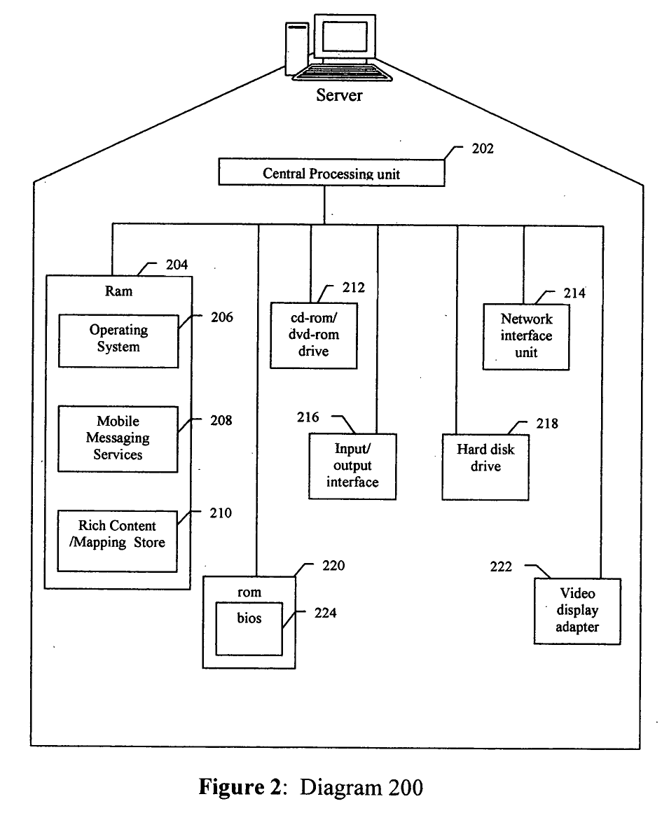

One embodiment of MMG 135 is described in more detail below in conjunction with FIG. 2. Briefly, however, MMG 135 may include any computing device capable of communicating with mobile device 105. Such devices include personal computers, desktop computers, multiprocessor systems, microprocessor-based or programmable consumer electronics, network PCs, servers, and the like.

MMG 135 may be further configured to receive a message notification associated with a message from Web Server 130. In response, MMG 135 may format a short message, such as a SMS message, MMS message, or the like, and send the formatted message towards mobile device 105. In one embodiment, the short message includes a Uniform Resource Locator (URL).

The URL may further include a unique MSG ID associated with an email WAP page stored on the server side. The unique MSG ID may be generated based on any of a variety of mechanisms, including, but not limited to a counter, a MD5 hash, and the like. Web Server 130 may employ a mapping store (not shown) to save the mapping, i.e. the unique MSG ID and the location of the email WAP page.

Web Server 130 may include any computing device capable of connecting to mobile device 105, MMG 135, and the like, to receive a request, process a request, and send response back to the mobile devices and the like. Such devices include personal computers, desktop computers, multiprocessor systems, microprocessor-based or programmable consumer electronics, network PCs, servers, and the like.

Web Server 130 may be configured to receive the request, for example, from PC desktop 125. Web Server 130 may determine whether the intended recipient of the message is configured to receive the message in a mobile browser readable format.

Web Server 130 may store the rich content elements at a location that may be determined based, in part, on at least one of the user id, file identifier, device number, and the like. In one embodiment, Web Server 130 may store the rich content elements at a server that may be one of a plurality of servers (not shown), or the like.

Although MMG 135 and Web Server 130 are illustrated as distinct computing devices, the present invention is not so limited. For example, the functionality of MMG 135 and Web Server 130 may be associated with a single computing device, or spread across multiple computing devices, without departing from the scope of the invention.

Desktop computing device 125 represents virtually any device enabled to make a network request to another computing device, including but not limited to Web Server 130, MMG 135. Such devices include personal computers, webcam, desktop computers, multiprocessor systems, microprocessor-based or programmable consumer electronics, network PCs, servers, and the like.

Illustrative Server Environment

FIG. 2 shows one embodiment of a server, according to one embodiment of the invention. Server 200 may include many more components than those shown. The components shown, however, are sufficient to disclose an illustrative embodiment for practicing the invention. Server 200 may represent, for example, MMG 135 of FIG. 1.

Server 200 includes processing unit 202, video display adapter 222, and a mass memory, all in communication with each other via a bus. The mass memory generally includes RAM 204, ROM 220, and one or more permanent mass storage devices, such as hard disk drive 212, tape drive, optical drive, and/or floppy disk drive. The mass memory stores operating system 206 for controlling the operation of server 200. Any general-purpose operating system may be employed. Basic input/output system (“BIOS”) 224 is also provided for controlling the low-level operation of server 200. As illustrated in FIG. 2, server 200 also can communicate with the Internet, or some other communications network, such as network 120 in FIG. 1, via network interface unit 214, which is constructed for use with various communication protocols including the TCP/IP protocol. Network interface unit 214 is sometimes known as a transceiver, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM or other optical storage, magnetic cassettes, magnetic tape, magnetic disk storage or other magnetic storage devices, or any other medium which can be used to store the desired information and which can be accessed by a computing device.

The mass memory also stores program code and data. One or more applications are loaded into mass memory and run on operating system 206. Examples of application programs include multimedia uploading programs, multimedia format converting programs, schedulers, database programs, web server programs, mobile markup language processing programs, SMS programs, MMS programs, WAP push programs, and so forth. Mass storage may further include applications such as mobile messaging service 208 and rich content mapping store 210.

Mobile messaging service 208 may further receive a mobile message, such as a message notification, indicating that a mobile device is enabled to receive a mobile browser readable message, that a message is available for the mobile device, and the like. Mobile messaging service 208 may also receive Meta information, such as an account id, email WAP page identifier, and the like.

Mobile messaging service 208 may further send a short message, such as an SMS message, an MMS message, WAP push message, and the like, to the targeted mobile devices. The short message may include a link, script, executable, program, and the like that enables access to the email WAP page. In one embodiment, the link is a URL that includes the unique MSG ID that points to the location of the email WAP page stored on server.

Although illustrated in FIG. 2 as distinct components, mobile messaging service 208 and mapping store 210 may be arranged, combined in any of a variety of ways, without departing from the scope of the present invention. Moreover, messaging service 208 and mapping store 210 may reside in one or more computing devices, substantially similar to server 200.

Server 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion.

Server 200 also includes input/output interface 216 for communicating with external devices, such as a mouse, keyboard, scanner, or other input devices not shown in FIG. 2. Likewise, server 200 may further include additional mass storage facilities such as CD-ROM/DVD-ROM drive 212 and hard disk drive 218. Hard disk drive 218 may be utilized to store, among other things, application programs, databases, rich content elements, email WAP pages, and the like.

Messaging Process

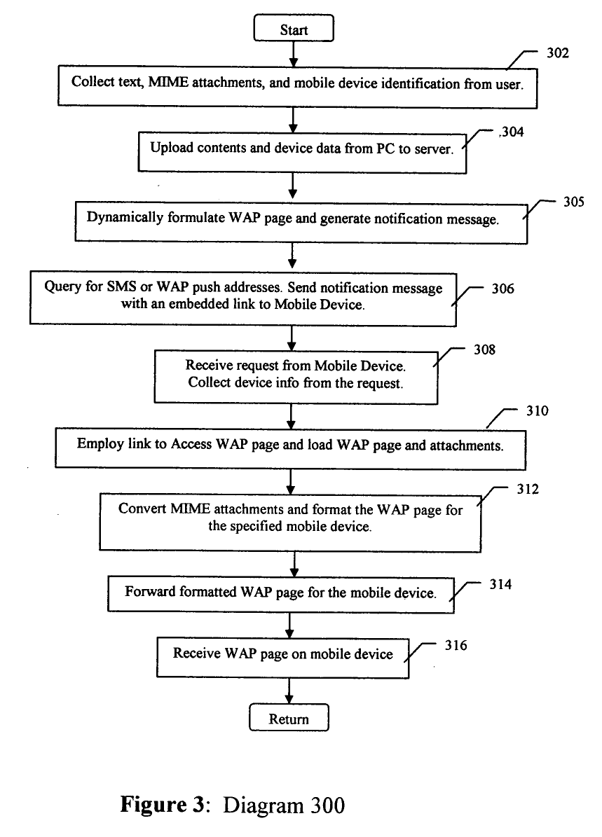

The messaging process of the present invention will now be described with respect to FIG. 3. FIG. 3 is a flow diagram generally showing one embodiment of a simplified scheme to deliver email messages that include texts and/or MIME attachments from desktop computing devices to multimedia capable phones.

For ease of understanding, the process 300 employs a SMS message or WAP push message as the notification with an embedded URL as the link to the dynamically created email WAP page. However, the present invention is not so limited and virtually any mobile messaging vehicle may be employed to deliver the notification. Additionally, virtually any link may be employed to enable access to the email WAP page, including a URL, a script, an executable, a program, and the like.

The process 300 begins, after a start block, at block 302, where users compose email messages and provide info about the targeted mobile devices. The user input includes, but not limited to, texts and/or MIME attachments and the recipient mobile device numbers.

Processing continues to block 304 where the message body and/or attachments are uploaded into server and stored. A device number associated with the mobile device for each recipient is also forwarded to the server. The device number may be a phone number, and the like. Processing continues to block 305 where an email WAP page is dynamically created using the text message body and/or the MIME attachments. For each dynamically created email WAP page, a unique MSG ID is generated using any of a variety of mechanisms, including a counter, a MD5 hash, and the like. The unique MSG ID is mapped via a mapping mechanism to the email WAP page. The attachments are further associated with the unique MSG ID. The unique MSG ID will be sent as part of the notification message to the targeted mobile devices and will be used later to retrieve the email WAP page.

Processing continues to block 306 where a notification message is generated. The notification message contains a link that points to the email WAP page. In one embodiment, a URL is included in the notification message. By querying the service provider database using mobile device numbers and looking up the domain routing table for the specific service provider, the messaging address such as the SMS, MMS, or WAP push addresses are constructed. If the delivery is via MMS, the entire email message is delivered as a MMS message. Otherwise, the notification message is sent by the server to the SMS or WAP push addresses associated with the mobile device numbers.

Processing flows next to block 308, where the mobile device requests the email WAP page by invoking the link within the notification message. The mobile device identifier may also be sent to the server along with an HTTP request from the mobile device. The server receives the HTTP request from the mobile device. The server also collects device information from the HTTP request and/or user agent profiles, or the like on the fly. The server further queries more device information from the mobile device database for device capabilities, display and the MIME formats supported by the device.

Processing next continues to block 310 as in one embodiment, where server identifies the unique MSG ID (sent as part of the link contained in the notification message) from the HTTP request to retrieve the email WAP page and/or its attachments. The email WAP page and/or MIME attachments are loaded into memory. The processing then flows to processing block 312, where the server converts the MIME attachments to formats supported by the requesting mobile device. It may further format and optimize the display of the email WAP page according to the specified mobile device.

At block 314, the formatted and optimized email WAP page is delivered to the targeted mobile device. At block 316, the email WAP page is received by the mobile device. The email WAP page can then be viewed by the recipient.

Logical Components and Data Flow

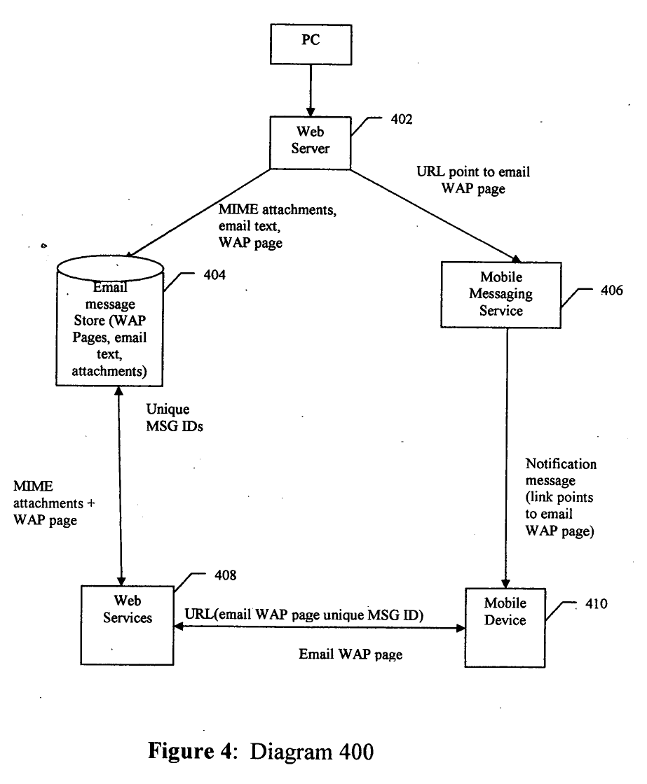

FIG. 4 illustrates logical components and data flow that may be involved during the processes specified in FIG. 3. As shown in the figure, the flow 400 includes web server 402, email message Store 404, mobile device 410, web service 408, and Mobile Messaging Service 406. Mobile messaging service 406 is in communication with Web Server 402 and mobile device 410.

Web services 408 may operate as a component within Web Server 402, or operate within another computing device, or as a combination of MMG 135 and the other computing device.

Mobile device 410 may communicate with mobile messaging service 406 to receive the SMS message with an embedded link. Mobile device 410 may also communicate with Web Services 408 to fetch the email WAP page.

Web Server 402 handles all requests from PCs and from mobile devices. In one embodiment, Web Server 402 is enabled to display a web form upon an http request, and then process the form to upload and store the email message body and/or MIME attachments, to collect the info about mobile device. The uploaded attachments are saved into the email message store 404.

Mobile messaging service 406 finds the messaging address (such as SMS or WAP push addresses) associated with mobile device numbers, generates and delivers notification message to mobile devices. It receives the notification request from Web Server 402, along with the unique MSG ID for the email WAP page and the like. Mobile messaging service 406 then generates a short message, such as an SMS message, and the like, that includes a link, such as a URL. Mobile messaging service 406 then finds the messaging address (such as SMS or WAP push addresses) of mobile device 410 by querying the service provider database using mobile device numbers and looking up the domain routing table. The short message with an embedded link, and the like, is sent to messaging address (such as SMS or WAP push addresses) associated with mobile device 410.

Mobile device 410 sends a request link to web service 408, where the request link includes at least the link pointing to the stored email WAP page. Mobile device 410 may also send its device identifier to web service 408.

Web service 408 receives the request for the email WAP page from the mobile device. Web service 408 employs the associated information, including the link, device number, and the like, to access the email WAP page and/or MIME attachments stored in the email message store 404. Web service 408 also collects device information from the request on the fly. Web service 408 further queries more device information from the mobile device database to find out about the device capabilities, display and the MIME formats supported by the device. Web service 408 then converts the MIME attachments to formats supported by the requesting mobile device. Web service 408 may further format the email WAP page according to the recipient mobile device. The MIME attachments embedded into the email WAP page can be readily viewed, downloaded, and played on the mobile device. Web service 408 then send the formatted email WAP page to mobile device 410.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A client, server, and method providing a simplified scheme to deliver email messages that include texts message body and/or MIME attachments from desktop computing devices to messaging (such as SMS) and wireless internet capable phones, comprising:
Providing a seamless email to phone option within existing WEB email or email client for users to send emails to mobile phones;
Uploading text message body and/or MIME attachments from user's desktop computing device to server;
Collecting targeted mobile device info such as phone number from sender;
Storing message body and/or MIME attachments on server;
Creating an email WAP page using message body and/or MIME attachments;
Generating a unique MSG ID for each dynamically created email WAP page using any of a variety of mechanisms, including a counter, a MD5 hash;
Mapping the unique MSG ID to the email WAP page;
Storing the created email WAP page on server;
Providing a routing table that specifies delivering mechanisms and the associated messaging domains for mobile service providers;
Building the unique email like messaging address for a given mobile number, such as SMS, MMS, or WAP push address;
Generating a notification message with a link pointing to the email WAP page;
Sending a notification message to the unique messaging address (such as SMS or WAP push address) of the mobile device;
Employing the link to access email WAP page;
Collecting device info on the fly from HTTP header and/or user agent profiles and querying a device database to find supported MIME, display and capabilities, etc;
Converting the MIME attachment elements to formats supported by the requesting mobile device so that the attachments can be viewed, downloaded and saved on the requesting mobile device.
Formatting and optimizing the email WAP page for display on the particular mobile device;
Delivering the email WAP page to the mobile device for viewing, saving, and downloading.

2. The method of claim 1, wherein automatic recognizing the recipient as a mobile phone comprise of
Providing an explicit “send to phone option” within existing internet or email client;
Scanning To/CC/BCC email fields to intelligently infer whether recipient is a mobile phone number;

3. The method of claim 1, wherein creating an email WAP page dynamically with email message body and/or MIME attachments.

4. The method of claim 1, wherein providing a routing table that specifies the delivering mechanism and messaging domain name of each service provider for delivering emails.

5. The method of claim 1, wherein creating a link that can be used to invoke a request from mobile device to retrieve the email WAP page that contains message body and/or all the MIME attachments.

6. The method of claim 5, wherein the link further comprises of a Uniform Resource Locator (URL), a script, an executable, program, and the like.

7. The method of claim 1, wherein building email like unique messaging address (such as SMS or WAP push address) from mobile device number comprises of:
querying a service provider database to find service provider for a given device number;
looking up domain name from domain routing table using the service provider;
Combining the device number and domain name to formulate email like messaging address.

8. The method of claim 1, wherein sending the notification message to mobile device further comprises:
Associating the link with the email WAP page;
Associating the link with all the MIME attachment elements within the email WAP page;
Sending the notification message including the associated link to the mobile device, wherein the link is employable to locate the email WAP page and/or all the MIME attachments on the server.

9. The method of claim 1, wherein offering options to specify multiple recipients of the email message and delivering notifications to a group of devices at the same time.

10. The method of claim 1, wherein collecting the information about the mobile device from the request of the mobile device on the fly.

11. The method of claim 10, wherein device info collected on the fly via user agent profile and/or HTTP headers;

12. The method of claim 10, wherein using the info collected about a device on the fly through requests to query a device database to find out about the capabilities, display, formats and the like supported by the device.

13. The method of claim 1, wherein converting MIME attachments into formats that are supported by the mobile device so that they can be saved, viewed, downloaded and played on the mobile device.

14. The method of claim 1, wherein using all the device capability info collected to format the email WAP page for display on the particular mobile device.

15. The method of claim 1, wherein the uploaded MIME attachments and message body are stored in an email message store.

16. The method of claim 3, wherein the email WAP page contains links to MIME attachments. Users can use those links to view, download, and save the MIME attachment elements.

17. The method of claim 1, wherein the email WAP page is formatted and optimized according to the mobile device identified from the request.

18. The method of claim 1, wherein providing a device database that provides specifications and capabilities of each device, such as device's supported MIME types, screen displays and the like.

19. In addition to claim 1, the simplified scheme may further comprise authenticating the request to retrieve the email WAP page using mobile device numbers, wherein the authentication of recipients further comprises
Associating the generated unique MSG ID to the mobile device numbers of recipients;
Storing the association between the unique MSG ID of email WAP page and the mobile device number of the recipient.
Prompting user to enter mobile device number at the time of retrieving the email WAP page;
Validating the mobile device number against the saved device number in the association between the mobile device number and the unique MSG ID of email WAP page.

20. A server for managing a communication with a mobile device over a network, comprising:
Handling http request from PC;
A transceiver for receiving and sending messages to the mobile device;
Receiving MIME attachments and saving them into email message store;
Creating a email WAP page that contains links to all the MIME attachments stored in the server;
Generating a unique MSG ID for each email WAP page;
Mapping the unique MSG ID to each email WAP page;
Building email like messaging address by querying a service provider database and looking up a domain routing table.
Delivering a notification message to the mobile device, wherein the notification message includes a link;
Handling http request from the mobile device for the email WAP page using the link;
Employing the link to enable access to the email WAP page;
Saving the association between the mobile device number and the unique MSG ID of the email WAP page for authentication of recipients;
Collecting characteristics of the mobile device from the mobile request.
Querying device database for additional device information.
Converting MIME attachment elements to formats supported by mobile device so that the MIME attachments can be viewed, saved, and downloaded to the targeting mobile device;
Formatting the email WAP page for display on a particular mobile device;
Delivering the email WAP page to mobile devices.
